(19) United States
(12) Patent Application Publication
(10) Pub. No.: US 2014/0280604 A1
(43) Pub. Date: Sep. 18, 2014

(54) ADAPTIVE DISTRIBUTED APPLICATION STREAMING

(71) Applicants: Yavuz Ahiska, Esher (GB); Bartu Ahiska, Esher (GB)

(72) Inventors: Yavuz Ahiska, Esher (GB); Bartu Ahiska, Esher (GB)

(21) Appl. No.: 14/211,558

(22) Filed: Mar. 14, 2014

Related U.S. Application Data
(60) Provisional application No. 61/791,514, filed on Mar. 15, 2013.

(51) Int. Cl. H04L 29/06

(52) U.S. Cl. CPC H04L 29/06034
USPC 709/205

(57) ABSTRACT

Methods and systems for remotely provisioning immediately executable virtualized applications using a peer-to-peer network. Immediately initially executable portions of virtual applications, or additional components of virtual applications, or a combination thereof, are served onto user desktops from other peers on the peer-to-peer network when applications are selected for use.

### CROSS-REFERENCE

This application claims priority to copending U.S. Provisional Application No. 61/791,514, filed Mar. 15, 2013, which is entirely incorporated herein by reference.

### BACKGROUND OF THE INVENTION

Various aspects of cloud-based gaming and application streaming may be found in the following references, all of which are incorporated herein by reference in their entireties:

U.S. patent application Ser. No. 13/458,437, “Adaptive application streaming in cloud gaming”; U.S. patent application Ser. No. 13/458,618, “Adaptive cloud-based application streaming”; U.S. patent application Ser. No. 13/458,481, “Application Distribution Network”; U.S. patent application Ser. No. 13/873,382, “Adaptive application selection in cloud gaming”; U.S. Pat. No. 6,453,334, “Method And Apparatus To Allow Remotely Located Computer Programs And/Or Data To Be Accessed On A Local Computer In A Secure, Time-Limited Manner, With Persistent Caching”; U.S. Pat. No. 7,451,196, “Method And System For Executing A Software Application In A Virtual Environment”; U.S. Pat. No. 7,062,567, “Intelligent Network Streaming And Execution System For Conventionally Coded Applications”; U.S. Pat. No. 6,918,113, “Client Installation And Execution System For Streamed Applications”; U.S. Pat. No. 6,959,320, “Client-Side Performance Optimization System For Streamed Applications”; U.S. Pat. No. 7,043,524, “Network Caching System For Streamed Applications”; U.S. Pat. No. 7,096,253, “Method And Apparatus For Streaming Software”; U.S. Pat. No. 7,577,751, “Software Streaming System And Method”; U.S. Pat. No. 5,796,952, “Method and apparatus for tracking client interaction with a network resource and creating client profiles and resource database”; U.S. Pat. No. 7,149,761, “Systems And Method For Managing The Synchronization Of Replicated Version-Managed Databases”; U.S. Pat. No. 7,240,162, “System and Method for Predictive Streaming”; U.S. Pat. No. 7,337,127, “Targeted Marketing System and Method”; U.S. application Ser. No. 10/005,729, “Optimized Server For Streamed Applications”; U.S. application Ser. No. 11/273,862, “Streaming From A Media Device”; U.S. application Ser. No. 11/388,381, “System And Method For Tracking Changes To Files In Streaming Applications”; U.S. application Ser. No. 11/453,301, “Intelligent Network Streaming And Execution System For Conventionally Coded Applications”; U.S. application Ser. No. 11/977,187, “Rule-Based Application Access Management”; U.S. application Ser. No. 12/062,766, “Deriving Component Statistics For A Stream Enabled Application”; U.S. application Ser. No. 12/062,789, “Opportunistic Block Transmission With Time Constraints”; U.S. application Ser. No. 12/509,210, “Software Streaming System And Method”; U.S. Pat. No. 7,043,558, “Data communication apparatus and data communication method”; U.S. Pat. No. 7,613,770, “On-demand file transfers for mass P2P file sharing”; U.S. Pat. No. 7,995,473, “Content delivery system for digital object”;

The following additional literature is also incorporated herein by reference:
Moore, D. and Hebeler, J. (2001). Peer-to-peer. Osborne/McGraw-Hill
Oram, A. (2001). Peer-to-peer: Harnessing the power of disruptive technologies. O'Reilly Media
Choon, H., Sarana, N., Rajkumar, B. (2003). P2P networks for content sharing. Technical report, GRIDS-TR-2003-7, Univ. of Melbourne, Australia
Ratnasamy, S., Francis, P., Handley, M., Karp, R., Shenker, S. (2001). A scalable content-addressable network. SIGCOMM 2001:161-172
Application Jukebox User Guide v8.3, Endeavors Technologies Inc.
Application Jukebox Server Administration Guide v8.2, Endeavors Technologies Inc.
Software2 Reporting Interface for Application Jukebox

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1a shows an example of a first PC serving a Partial of a virtualized application, such as a game, to second PC using a peer-to-peer (P2P) network, in accordance with various embodiments of the current disclosure.

FIG. 1b shows an example of the general principal of the process of communication and/or sharing components of a virtual game(s) between nodes in a P2P network, in accordance with various embodiments of the current disclosure.

FIG. 2a shows an example of a plurality of PCs in a P2P network that are capable of delivering or receiving portions of a virtualized game, in accordance with various embodiments of the current disclosure.

FIG. 2b shows an example of a possible structure for the graph of connections between active nodes in a P2P network for the process of communication and/or sharing components of a virtual game(s) with various embodiments of the current disclosure;

FIG. 3 shows an example of a target device that is connected to a P2P network for exchanging at least a portion of a virtualized game and/or modifying component of a virtualized game, in accordance with various embodiments of the current disclosure;

FIG. 4 shows an example of a plurality of application stations in a P2P network, at least some of which are capable of delivering and some of which are capable of receiving portions of at least one virtualized game, in accordance with various embodiments of the current disclosure; and

FIG. 5 shows an example of a first game station serving requested blocks or pages of a virtualized application identified by a unique identification number to second game station using a P2P network, in accordance with various embodiments of the current disclosure.

### DETAILED DESCRIPTION OF SAMPLE EMBODIMENTS

### Application Virtualization

Application virtualization improves portability, manageability, copy protection and compatibility of applications, such as games, by encapsulating them from the underlying operating system on which they are executed. It enables applications to be seamlessly and remotely deployed and maintained. A fully virtualized application does not need to be installed to be executed. The application is fooled at runtime into believing that it is directly interfacing with the original operating system and the resources managed by it, when in reality it may not be.

### Application Streaming

Application streaming is a software distribution methodology designed to accelerate software distribution by delivering only currently-required program data to a target device. Users can execute software on a target device without a complete version of the software already present on the device. Effectively, executable portions of the application are buffered ‘on demand’.

### Paging

As described in U.S. Pat. No. 7,062,567, application streaming may be achieved using a system that partitions an application program into “page segments” or “pages” (also sometimes referred to as chunks or blocks). Pages may be formed by observing the manner in which the application program is conventionally installed and executed.

Pages are arbitrarily sized portions of a streamable application and may consist of, for example. one or more software instructions, a portion of multimedia data, a portion of a game engine, one or more portions of one or more application files or registry entries, or any combination thereof. Pages may be fixed or variable in size. For example, highly correlated portions of an application may be grouped together into larger pages. Generally, any application can be delivered in page form (e.g., via application streaming); however, some applications may require a larger portion of their corresponding software to be present on a target device at runtime than others.

A further embodiment of paging is to use a predictive engine (“predictive paging”). The predictive engine tries to deliver pages to the target device in advance of when they are needed or requested. It is particularly advantageous to deliver pages indicated by a predictive engine when attempted execution of the indicated pages will cause a page fault.

In some embodiments, an application is predictively streamed from the cloud server, in part or in entirety, by receiving a request for a first page segment of a streaming application, checking a page segment request database, predicting a second page segment request based on the page segment request database, and sending, in response to the request, data associated with the first page segment and data associated with the second page segment. In an embodiment, the page segment request database includes probabilities or means for determining probabilities that a second page segment will be requested given that the first page segment has been requested. In another embodiment, the technique further includes piggybacking the data associated with the second page segment on a reply to the request for the first page segment.

### STREAMING DEFINITIONS

“Pagefeeding” is defined herein as delivery of pages by an application source to a target device using streaming.

“Streaming” is defined herein as delivery of portions, such as pages, or an application during execution of the streaming application.

An “application source” or “appfeeder” is defined herein as storage and corresponding physical or logical controls that can act as a source for delivery of an application to a target device. An application source for an application may comprise one or many memories or other forms of software repository, localized or distributed, that can be controlled to result in download of the given application to the target device.

A “pagefeeder” is defined herein as one or more application sources that, together, are capable of pagefeeding to a target device. A pagefeeder may include application sources that, by themselves, cannot perform pagefeeding.

### Partials

In practice, only a partial “seed” portion of an application (“Partial”) may be required to launch and provide at least initial functionality of an application on a target device. A Partial may comprise, for example, either directly or as page segments, portions or all of a minimum set of files, directory information, registry entries, environmental variable changes, or some combination thereof required for launching the application. A Partial may include an application's executable and DLLs that are necessary for execution. In some cases, a Partial may comprise the initial execution environment of an application. The contents and size of a Partial may be adjusted depending, for example, on the total size of the application and the application functions intended to be made initially available.

### Client/Server Model

One method of distributing a virtualized computer game is to use a cloud based server(s) to stream portions or pages of the application to one or more target devices.

Instant gratification gaming can be achieved using Cloudpaging and Application Jukebox. Using Application Jukebox, an application is packaged into a pre-virtualized form. The Partial is then intelligently delivered over a network from a cloud server to an end user's target device. With only this Partial, the user can jump into a virtualized form of demanding graphics-intensive software, while the remainder of the application is delivered to the target device's persistent cache seamlessly in the background from the cloud. Partials can advantageously be delivered in encrypted form in order to enhance Digital Rights Management (DRM) and license control. DRM can be managed by the pagefeeder, or separate server in the cloud.

Client/server architecture is a well adopted, powerful topology. However, in some implementations, the client/server model of delivering virtualized games to target devices could ecounter a number of difficulties due to the hierarchical structure. Key application resources may be centralized on a finite number of servers, with performance confined to a limited geographic area. This could hinder the scalability and fault tolerence of the system, especially as the growing number of Internet users are scattered all over the world. These difficulties can be addressed in a number of ways, including, but not limited to, installing a greater number of servers to create redundency, and/or using a distributed Content Delivery Network (CDN), and/or using IP multicasting to offload the work from the original servers by improving bandwidth utilization and increasing content availability. Another method of addressing these issues is to use a peer-to-peer network (P2P) topology to facilitate distribution application components, such as, for example, a Partial, an additional component, a mod, a patch, an ungrade, or a combination thereof.

### Peer-To-Peer Networks (P2P)

In a P2P network, software and media files are widely distributed among a plurality of nodes (“peers”, “members”). The files are shared by direct exchange between these nodes. Typically every node acts as both a client (“target”) and router or server (“source”). As well as benefiting from files from the P2P network, nodes can also contribute files to the network. When a node completely or partially downloads a file, it typically becomes an additional source for its peers in the P2P network.

Since every node has a similar role, it is possible to add more and more nodes to scale the network.

A P2P network typically has no central point of failure and has built-in file replication. The structure of the network is typically dynamic as nodes are allowed to enter and leave over time, and the nodes are left to self-organise.

A P2P network may be formed via, for example, a communication network such as the Internet, a Wide Area Network (WAN), a Local Area Network (LAN), or any combination thereof.

There are a number of implementations of P2P networks for file sharing, the majority of which is typically music and video content, such as, for example, Napster (www.napster.com), Gnutella (www.gnutella.com) and Kazaa (www.kazaa.com). The deployed architectures can typically be described by the following not mutually-exclusive categories: (i) centralized vs. decentralized, (ii) structured vs. unstructured, (iii) whole file vs. chunk based.

Centralized Vs. Decentralized

With a centralized P2P network, the nodes each upload a list of their shared files to a central server. The central server is responsible for storing this index information and responding to file search queries submitted by nodes seeking assets. When a query is submitted by a first target node, the server responds with the IP address of one of more second source node(s) with the matching file. The first node may then make a direct connection to the second node(s) to obtain the file. The file transfer does not go through the central server.

With a decentralised P2P network, the first target node queries its neighbouring peers, not a server, for a file. These neighbours then forward the query onto their neighbours. This process is repeated until a maximum “time to live” number of query levels is reached, or until peers are found with a file matching the query. If found, the file is then transferred directly from the asset-holding source node(s) to the first target node. Unlike the centralized approach, this architecture does not have a central point of failure and is also less susceptible to hostile denial of service attacks.

Hybrid P2P networks also exist in which some peers act as “super-peers” (or “super-nodes”). In effect, each super-peer is responsible for acting as a query server for a small portion of the P2P network. Ordinary peers upload their file list to a super-peer, and super-peers may also occasionally swap file list information.

Structured Vs. Unstructured

Unstructured P2P networks are built from peers that are linked together arbitrarily, without a globally consistent topology protocol. In contrast, structured P2P networks have a structured topology pattern that guarantees a file can be found, even if it's occurrence is rare in the network. Such networks commonly deploy a Distributed Hash Table (DHT) to route queries. This decentralized DHT data structure makes a structured P2P network very scalable.

Whole File Vs. Chunk Based

While some early P2P networks directly exchanged unbroken files between peers, other more recent P2P implementations break the delivered file(s) into smaller subunits, often called “chunks” or “pieces”, for delivery. Rather than download a file from a single source peer, a target device may join a “swarm” of hosts to download multiple chunks simultaneously.

### P2P Partial Distribution Management

In a preferred embodiment, a Partial can contain all of the software assets necessary to instantly run a corresponding virtualized application, such as a game. In a preferred embodiment, a virtualized game—and indeed even the operating system—believe that the game is traditionally installed and fully resident on the host target device, while in reality, only at least the Partial may be resident. In some embodiments, the Partial may be encapsulated as, for example, a single file, collection of a plurality of files, compressed archive, or other computer readible software container(s).

In the preferred embodiment, a P2P network is used to push a Partial to a target device. In one embodiment, the target device requests the Partial from a cloud server that matches the target device to peer device(s) that have at least a portion of said Partial. In some embodiments, the target device pings the cloud server to connect to the P2P network. In some embodiments, a P2P agent is installed on the target device and arrives coded with the location(s) of cloud server(s) which is updatable.

In another embodiment, the target device contacts one or more peers in a P2P network to request the Partial.

FIG. 1a shows an example of a first PC (101) serving a Partial of a virtualized application, such as a game, to second PC (102) using a P2P network, in accordance with a preferred embodiment. Once the Partial has been delivered to the second PC, a designated cloud server (100) delivers the remainder of the virtualized game corresponding to said Partial. In some embodiments, more than one PC simultaneously serves different subsets of the requested Partial to the second PC (102) using chunk based delivery. In some embodiments, said delivery of the remainder from the cloud server (100) is by application streaming or paging. In some embodiments, the second PC (102) attempts to page at least a portion of a virtualized game from the first PC (101); if the correct page(s) are not found, the cloud server (100) supplies them directly to the second PC (102).

FIG. 1b shows a more detailed example than FIG. 1a of the general principal of the process of communication and/or sharing components of a virtual game(s) between nodes in a P2P network.

In a preferred embodiment, virtualized games distributed by a P2P network have DRM protection that is managed by a pre-designated cloud server. A target device requires authentication that they have a right to use the virtualized game before the main functionality of said virtualized game is executed. In a preferred embodiment, the Partial is distributed over a P2P network in an encrypted state.

In some embodiments, DRM management of an application is managed using the P2P network (for further embodiments, see P2P DRM section below).

### P2P Streaming

Some embodiments deliver a greater proportion, or the entirety, of a virtualized application, such as a game, using a P2P network.

FIG. 2a shows an example of a plurality of PCs (200)-(203) in a P2P network that are all capable of delivering or receiving portions of a virtualized game, in accordance with an embodiment. In some embodiments, a first target device (200) executing a virtualized game makes a concurrent request to the P2P network for an additional component required for the continued use of the application. One or more of the peer devices (201)-(203) deliver said additional component to the first device (200). In some embodiments, said additional components may be a single file, collection of a plurality of files, compressed archive, or other computer readible software container(s). In some embodiments, multiple peers concurrently deliver different portions of said additional component in parallel.

In some embodiments, a target device frequently requests additional blocks or pages of a virtualized game from the P2P network to be delivered by application streaming from the P2P network peers. In some embodiments these requested additional blocks or pages of a virtualized game are identified using a combination of a unique application identification number and a unique page (block) identification number.

In some embodiments, a P2P network is used to automatically deliver a new portion of a virtual game to a target device as the user of said target device reaches a trigger point in the game. Said portion may be, for example, but not limited to, a new map, texture, song, audio segment, video, text, in-game purchase, wireframe model or other 3D geometry representation, game “mod” or character. Said trigger point may be, for example, but not limited to, a set time or location point reached during gameplay, a specific previous asset being accessed or fetched, a manual command from the user, or an automatic instruction emitted from the game, operating system or the virtualization hook.

In some embodiments, peers deliver pages of a virtualized game over a P2P network to a target device in a similar on-demand manner to the cloud server in an Application Jukebox architecture.

In some embodiments, a P2P agent executing on a target device is used to upload or download User Game Episode Memory (UGEM) to or from storage in a cloud server(s) or super-node(s) or peer(s) using a P2P network. UGEM may be, for example, but not limited to, saved game information, profile or characteristic of a game character, and in-game social network conversation history. In some embodiments, a user may user any node in the P2P network to continue playing a game from the last saved break by accessing their UGEM from the P2P network, wherein said UGEM is stored on another node, such as their original home device, a super-node, a cloud server, or stored divided amongst a combination of nodes in the P2P network. In one embodiment, wherein the UGEM corresponding to a user is stored on node(s) in a P2P network, said node(s) are chosen by their physical proximity, or ping distance, to the user's device when, for example, the first UGEM upload was made, or the user first registered to the P2P, or the user's last known connection location.

In some embodiments corresponding to FIG. 2a, a first target device (200) may obtain application blocks or pages from any one or more other source peer devices in the P2P network that have the requested block or page in local memory (201-203). In some embodiments the first target device (200) selects one or more peer devices (201-203) depending on their suitability. Suitability can be measured by weighting, calculated using, for example, availability of peer devices (201-203), ping time to peer devices (201-203), current load of peer devices (201-203), contents of respective application or block libraries of peer devices (201-203), and compatibility of peer devices (201-203) with the first target device (200). In some embodiments, suitability of peer devices (201-203) is measured by the first target device (200) when an initially immediately executable portion of a virtual application is launched on the first target device (200). In some embodiments, the peer device(s) (201-203) chosen for provisioning of an application may change dynamically during runtime (or otherwise during provisioning), and the suitability of peer devices (201-203) can be determined periodically, continously or at predefined or otherwise various points during provisioning. In some embodiments a Distributed Hash Table is used to determine how requested application blocks are routed from suitable peer devices (201-203) to the first target device (200). In some preferred embodiments, each suitable peer device (201-203) has an option whether to appect or decline participating in P2P application provisioning to the first target device (200).

FIG. 2b shows a more detailed example than FIG. 2a of a possible structure for the graph of connections between active nodes in a P2P network for the process of communication and/or sharing components of a virtual game(s).

### P2P Broadcasting

P2P networks have a number of advantages over IP multicasting of files, including, for example, that P2P networks require no common architecture (anyone can join by executing a P2P agent), and that P2P networks are more scalable as the total capacity of the system increases as more nodes arrives and demand on the system increases.

In a preferred embodiment, a cloud server uses a P2P network to broadcast a portion of a virtual game to target peers that constitute the game's user base, wherein said portion may be a Partial or additional component.

In a preferred embodiment, a cloud server uses a P2P network to propogate patches or upgrades to target peers. In some embodiments, patches can be either forcefully applied (they are automatically applied by the virtualization agent on any peer that obtains them). In some embodiments, the deployment of patches is optional (the user has a preference into whether the patch is applied).

In some embodiments, peers in a P2P network check with each other whether their virtual game is up-to-date with the latest patch or upgrade; if one node is using an outdated version, then the patch or upgrade is transferred between the peers in the P2P network.

### Predictive P2P Streaming

On-demand application streaming over a P2P network can at times suffer from Quality of Service (QoS) issues: nodes can dynamically leave and join the network; the response time of any node is not guaranteed; the network is composed of a heterogenous collection of nodes with differences in bandwidth, latency and computation performance.

One method of overcoming this potential shortcoming of on-demand streaming is to use predictive paging. In some embodiments an application is streamed to a target peer using predictive paging over a P2P network. When the request for a first page segment is made, a page segment database is used to determine a likely second page segment that should be also returned. This second page segment is returned after the first page segment, even though the second page segment has not been specifically requested. The aim of this activity is to pre-empt the request of the second page segment and reduce the probability of a page fault on the target peer. In some embodiments, the page segment database is a decentralized data structure that is distributed amongst the peers of a P2P network in a similar manner to a DHT. In some embodiments, as with DHTs, the responsibility for inserting, deleting and updating certain database entries are distributed to specific nodes.

In some embodiments, in which application sizes are not overwhelmingly large, each peer in the P2P network has a copy of the entire, or actively relevant portion, of the page segment database. Each target peer is itself responsible for predictively determining a second page to request from the P2P network. The page segment database is periodically synced to ensure that the distributed peers are kept up to date with changes.

### P2P Memory Management for Partials

In the preferred embodiment, streaming allows remote management of an application memory, such as a games library, on a user's target node.

In some embodiments, a cloud server selects one or more Partials and pushes them using a P2P network onto the user's target node. In some embodiments said pushing activity is done without the user having to request or otherwise select the corresponding virtual game. In one embodiment, the pushing activity is performed by the cloud server instructing a P2P agent on the target node to seek the selected Partial(s) in the P2P network by submitting a query.

In the preferred embodiment, the cloud server chooses Partials using Game Selection Heuristics. In some embodiments, Game Selection Heuristics may be, or derived from, user or franchise specified preferences. In some embodiments, Game Selection Heuristics may favor, for example, the sequel to a game that is already in a user's library; a different episode or level of a previously purchased game of the user; games belonging to a franchise that the user has previously made purchases from; games belonging to a specific game provider, publisher or developer; games similar to those previously played, downloaded or purchased by the user; games suggested by information available from a user's social network profile; games suggested by a user's behavioral history on websites such as shopping platforms; games recommended by other users; games selected for other users with similar preferences; or highly rated games. Game Selection Heuristics may also be biased towards selection of games or other applications as paid or otherwise contracted for by a publisher, retailer, developer, or other third party. The pushed Partial may encourage the user to trial any one or more of the corresponding games, with or without impulse purchase, or rental or other payment condition, and can jump straight into any of the corresponding games instantly with no network buffering delay. Use of Partials previously pushed onto the user's target device can cut the user's “time-to-play” to nearly zero, thus satisfying the gamer's desire for instant gratification.

In some embodiments, a first node in a P2P network selects one or more Partials using Game Selection Heuristics, and pushes said Partial(s) to a second target node. In these embodiments, Game Selection Heuristics may favor, for example, the sequel to a game that the user of the first node has previously played with the user of the second node; a game inferred from information sourced from a social network in which the users of the first node and second node are connected; a game that the user of the first node recommends; a game that the user of the first node recommends based on the social network profile of the user of the second node. In some embodiments the first node pushes the selected Partial(s) using a P2P network. In some embodiments, the first node recommends a cloud server to deliver the Partial(s) to the second node. In some embodiments a hybrid approach between P2P and cloud server delivery of the Parial(s) is used.

In some embodiments, a first node in a P2P network selects one or more additional components of a virtual game using Game Play Heuristics, and pushes said additional component(s) to a second target node using a P2P network. In one embodiment, the first node delivers an in-game asset(s), such as, for example, a new character or weapon or in-game gift purchase, to the second node using a P2P network for use with a virtual game. In some embodiments, said additional component interfaces seamlessly with the virtual game using Application Jukebox technology. In one embodiment, said additional component(s) are additional pages that are delivered via cloudpaging. In another embodiment, said additional compoenent(s) is an independently virtualizable container that communicates with the original virtualized game. Game Play Heuristics may be, for example, behavioural information learnt from a game that the user of the first node has previously played with the user of the second node; information sourced from a social network in which the users of the first node and second node are connected; additional component(s) recommendations of the user of the first node; recommendation(s) of the user of the first node based on the social network profile of the user of the second node.

In some embodiments, a P2P agent executing on a target device is used to share Game Play Heuristics with a cloud server(s) or super-node(s) or peer(s) for remote storage. This keeps action facilitates the availability of said Game Play Heuristics in the P2P network for future use in delivering additional components to the user of said target device, or different user(s) or target device(s). In some embodiments, the Game Play Heuristics from multiple users with shared profile attributes is combined to create inferred Game Play Heuristics for future use with a set of profiles with the same, or sufficiently similar, attributes. In some embodiments, P2P agents executing on nodes in a P2P network are used to sync Game Play Heuristics and/or UGEM between the set target devices that are directly used by, or in the same LAN as, a user.

In some embodiments, Game Play Heuristics stored on the P2P network are used to predictively stream additional components of a virtualized game to a target device, before said target device request said additional components over the P2P network. In some embodiments, predictive streaming based on Game Play Heuristics distributed on a P2P network is used to pre-load independently steamable levels or maps of a virtualized game onto a target device before the gameplay on said target device requires or has requested said levels or maps.

In some embodiments, a P2P agent executing on a target device is used to share Game Selection Heuristics with a cloud server(s) or super-node(s) or peer(s) for remote storage.

### P2P DRM

In some embodiments, DRM for an application running on a target node is enforced using a P2P network.

In some embodiments, a defined network footprint, such as the boundary of a LAN or physical geography, is issued a fixed number of licenses for an application by a cloud server. The nodes within said network footprint exchange the finite licenses with each other in a P2P network.

### Management of Peers

In some embodiments, a cloud server manages the resource availability and/or distribution amongst the peers in a P2P network.

In some embodiments, a cloud server manages the version of assets—such as a patch, upgrade or mod—that are available on a P2P network, resulting in old versions being replaced or removed from the network.

Implementing a Virtualization Client with P2P

FIG. 3 shows an example of a target device (300) that is connected to a P2P network (301) for exchanging at least a portion of a virtualized game (e.g. Patch or additional component) and/or modifying component (e.g. patch, upgrade or mod) of a virtualized game, in accordance with the preferred embodiment. In the preferred embodiment, the target device (300) is a PC. In some embodiments, the target device (300) has two agent processes: a P2P agent (302) and a Player agent (303). The P2P agent (302) facilitates the connection of the target device (300) to a P2P network (301), the nodes of which are also running an instantiation of the same P2P agent (302). The P2P agent (302) can access the local storage (304) memory on the target device (300) to store at least virtual components of a virtualized game.

In some embodiments, a user of the target device (300) instructs the P2P agent (302) to obtain and store the Partial for a virtualized game. In some embodiments, a cloud server broadcasts a Partial for a virtualized game and the P2P agent (302) automatically receives, stores and forwards to other peers a copy of said Partial.

In the preferred embodiment, the user of said target device (300) clicks on, or otherwise instruct, the Partial in the local storage (304) to begin execution. In some embodiments, the Player agent (303) automatically detects the Partial in local storage (304) and begin execution. In some embodiments, the P2P agent (302) communicates with the Player agent (303) when a Partial is obtained, and the Player agent (303) is subsequently ready to begin execution of the Partial when it automatically chooses or when it is instructed to by a user.

In the preferred embodiment, the player agent (303) virtualizes the Partial that is in local storage (304) and which was obtained from the P2P network (301). In the preferred embodiment, DRM for the virtualized game is managed from a remote DRM manager (305). In some embodiments, the player agent (303) communicates with the remote DRM manager (305) to authenticate the user session and allow or reject the execution of the virtualized game depending on the status of the user's software license.

In the preferred embodiment, the P2P agent (302) and player agent (303) are embodied in a single software application. In some embodiments, the P2P agent (302) is a component of the player agent (303).

In some embodiments, the P2P agent (302) and player agent (303) are separate software processes. In some embodiments, the player agent (303) is part of the Application Jukebox suite. In some embodiments, the P2P agent (302) is a 3^{rd} party module, such as, for example, BitTorrent (www.bittorrent.com).

FIG. 4 shows an example of a plurality of application stations in a P2P network, at least some of which are capable of delivering and some of which are capable of receiving portions of at least one virtualized game, in accordance with an embodiment.

FIG. 5 shows an example of a first game station serving requested blocks or pages of a virtualized application identified by a unique identification number to second game station using a peer-to-peer network, in accordance with an embodiment.

### Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims. In addition, the references cited in the background section of this disclosure show variations and implementations, as well as some features which can be synergistically combined with embodiments described herein.

In some embodiments, functions corresponding to Application Jukebox services may be divided up into a different number or different arrangement of services. Some present embodiments have been described in connection with Application Jukebox. In general, serving resources with functionality similar to the functionality of Application Jukebox discussed in corresponding embodiments may be employed instead of Application Jukebox.

In some embodiments, license types may be divided into a different number or different arrangement of permission types.

Some present embodiments have been described in connection with one or more PC(s), and/or game station(s), and/or application station(s), and/or target device(s), and/or peer device(s). In general, virtual applications disclosed herein may be delivered to a variety of target devices. A “game station” or “application station” or “target device” or “peer device” may be, for example, but not limited to, a PC, minicomputer, mainframe computer, console, set top box, smart TV, tablet, smart phone, smart vehicle environment (such as a car), programmable consumer electronics, distributed computing environment where tasks are performed by remote processing devices that are linked through a communications network.

Some present embodiments have been described in connection with computer games. In general, inventions disclosed herein can be applied to other software applications, as well.

What is claimed is:

1. A method for providing a remote software service, comprising the actions of:
when a user selects a particular application from available applications on an application station,
a) executing software corresponding to said particular application, said particular application being initially functionally executable without download immediately following said selecting; and
if said particular application comprises additional components not immediately functionally executable without download,
b) streaming from a peer-to-peer network to said application station at least one of said additional components, said streaming beginning contemporaneously with and continuing at least partially concurrently with said executing.

2. The method of claim 1, wherein ones of said additional components are immediately executable once they are streamed to said application station.

3. A method for remote application management, comprising the actions of:
using at least a first application station to push software over a peer-to-peer network to a second application station, said software corresponding to applications chosen to be available for execution on said second application station, said software being initially functionally executable without download immediately after selection using said second application station, said second application station being physically separated from said first application station; and
when a user selects a particular application for execution, if said particular application requires additional components to provide aspects of said particular application available to a user upon selection but said additional components are not immediately functionally executable without download,
using at least one application pusher to control streaming to said second application station of said additional components, said streaming beginning contemporaneously with said selection and continuing at least partially concurrently with said execution.

4. The method of claim 3, wherein once a portion of an application has been pushed or streamed to said second application station, said second application station can act as an application source with respect to said portion.

5. A remote game push control system, comprising:
a) a plurality of software-implemented games, at least one of said games comprising an immediately initially playable portion and at least one additional component separately transmissible from said portion, said components being integral to extended play of corresponding ones of said games; and
b) at least one first game station which:
pushes portions of at least one of said games over a network to a second game station, said portions of games including at least said immediately initially playable portions, said second game station being physically separated from said first game station
c) at least one game pusher which:
when a particular game is selected to be played on said second game station, if respective components corresponding to said particular game are not immediately playable without download, streams at least one of said respective components to said second game station.

6. A system of claim 5, wherein whether said additional components are resident in or streaming to said second game station is hidden from a user.

7. A system of claim 5, wherein said software is a pre-virtualized packaged version of said particular game.

8. A system of claim 5, wherein additional components may be selected by a user to be streamed to said second game station.

9. A system of claim 5, wherein a user can select at least one game to be included in said available games on said second game station.

10. A system of claim 5, wherein said first game station controls patching or updating of at least one game available for play on said second game station.
